(19) United States
(12) Patent Application Publication
(10) Pub. No.: US 2007/0006204 A1
(43) Pub. Date: Jan. 4, 2007

(54) Rtfs controls queue of requests from os

(75) Inventors: Robert Jochemsen, Eindhoven (NL); Mischa Geldermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKJKLE PHILLIPS ELECTRONICS N.V.

(21) Appl. No.: 10/545,651

(22) PCT Filed: Feb. 5, 2004
(86) PCT No.: PCT/IB04/50080

§ 371 Date: Aug. 16, 2005

(30) Foreign Application Priority Data
Feb. 21, 2003 (EP) 03100418.7

(51) Int. Cl. G06F 9/44

(52) U.S. Cl. 717/168; 717/170

(57) ABSTRACT

Real-time software and a non-time OS co-exist in a system, wherein the real-time software controls the requests from the non-real-time OS for access of a shared resource. The requests are put into a queue and the real-time software determines when which pending request gets executed.

### FIELD OF THE INVENTION

The invention relates to providing real-time (RT) data processing capabilities to a non-real-time (non-RT) operating system (OS). The invention relates in particular, but not exclusively, to combining a non-RT OS with an RT file system (RTFS).

### BACKGROUND ART

For RT recording on, e.g., a hard-disk drive (HDD) RT access to the disk is required. The HDD is shared between many processes. Careful scheduling is required if requests for access are guaranteed to get honored under RT conditions. A host OS (HOS) such as Linux provides access to the disk on the basis of “best-effort”, which is not sufficient for RT requirements. A non-RT OS typically has a scheduler that is optimized for high average performance under the condition that each process gets a fair portion of the bandwidth to the disk. On the other hand, RTFS software, which is used to provide RT storage, e.g., for storing video streams, comprises an RT scheduler for re-ordering disk requests in order to guarantee that all video streams are stored and retrieved under RT conditions. The inventors seek to solve the problem of, among other things, achieving RT behavior with a non-RT OS.

U.S. Pat. No. 6,466,962 discloses a system and method for supporting RT computing within a general purpose OS by means of co-resident operating systems. The RT systems technology is allowed to co-exist with commercial, general-purpose (non-RT) operating systems to support applications such as desktop multimedia conferencing. The central processor and other system resources are partitioned into two virtual machines. A first machine runs a largely unmodified general-purpose operating system, and a second machine runs an RT kernel. Access to the physical hardware is multiplexed by the virtual machines. A multiplexer is scheduled in advance to multiplex between the machines at precise periodic intervals, or the multiplexer is operated under control of an interrupt in response to a request of the RT OS to ensure that the RT kernel gets access to the hardware.

### SUMMARY OF THE INVENTION

The inventors propose a more advantageous alternative to known approaches to merge a non-RT OS with RT data processing. To this end, the invention provides an RT software stack that co-operates with the non-RT OS by intercepting the non-RT OS requests and controlling them in accordance with RT rules. More specifically, the invention relates to a method of implementing RT software co-existing with a non-RT OS to share one of more resources between the RT software and the non-RT OS. The method comprises enabling the RT software to check a queue of one or more pending requests from the non-RT OS for access of the resource; and enabling the RT software to determine when the pending request will be executed.

In the invention, the RT software is allowed to throttle the traffic in the non-RT OS according to RT rules. Requests from the non-RT OS are not executed immediately as they would be in the conventional case. The RT software controls the points in time at which the non-RT OS requests get executed.

For ease of explanation, the term “hook” is reserved in this text to refer to the communication channel between the RT software and the non-RT OS.

An embodiment of RT software co-existing with a non-RT OS according to the invention is one, wherein the RT software runs on the non-RT OS. In another embodiment the RT software runs outside of the non-RT OS. In case the RT-software is running on the non-RT OS, the OS needs to have some limited kind of real-time processing guarantees if the data handling as controlled by the hook is to be real-time guaranteed. Otherwise the RT-software might never have the chance to issue the commands to the hook. The RT-software is therefore preferably to run on a high-priority thread. Only the CPU processing of the OS needs to have such a provision. The hook mechanism leverages this to create real-time guarantees for other processes, e.g., access to an HDD or other resource. The required real-time provision can be fairly coarse-grained because the hook controls coarse-grained processing.

Preferably, the hook can be enabled and disabled at run time. When disabled, the non-RT OS operates as if the hook were absent. This allows booting in the conventional way. The hook recognizes requests from the RT software and lets them pass inmediately. This enables the RT software to use the relevant device driver(s) of the non-RT OS, and ensures that RT requests are executed without delay. The hook intercepts all requests from the non-RT OS, and puts them into a queue. This ensures that the non-RT requests do not interfere with the RT requests from the RT software. The hook further provides information to the RT software about the non-RT requests in the queue. This enables the RT software to determine execution of specific non-RT requests in a way that prevents them from interfering with the RT traffic. For example, the RT software determines the sequence wherein the non-RT requests are executed, so as to optimize resource usage.

Preferably, the hook is enabled to disable itself under specific conditions. For example, the hook disables itself when it detects that the RT software has stopped checking the queue of pending non-RT requests. This allows the system to recover from a state wherein the RT software has stopped working.

The above properties provide the following advantages to a system in the invention. The RT software can use the device drivers of the non-RT OS. The non-RT OS can boot as usual. Access to the hardware via the drivers is under full RT control. The RT software can be independent of the non-RT OS, e.g., the RT software runs outside, or on top of, the non-RT OS. AS a result, a portable RT software stack can be developed.

For disk access, time multiplexing as used in the known system, discussed above, is not advisable due to the relatively coarse granularity of disk requests. The inventors therefore propose a scheme for arbitration based on all available requests. This leads to a very significant difference between the known system and the invention. In the invention the RT disk scheduler determines the order of request execution for both the real-time requests and the non-RT requests. In the known system, this arbitration takes place on the bare processor, i.e., outside both the RT kernel and the general purpose kernel. The multiplexing is purely time-based, with some specific measures taken to solve conflicts between shared resources. Conflicts would otherwise cause the general purpose process to interfere with the real-time process. The invention avoids those conflicts altogether, since the disk scheduler ensures that a request from the general purpose OS is only executed at a time that it does never interfere with requests for real-time streaming.

### BRIEF DESCRIPTION OF THE DRAWING

The invention is explained in further detail, by way of example and with reference to the accompanying drawing wherein:

FIG. 1 is a block diagram of a system in the invention; and

FIG. 2 comprises tables of requests at various stages of operation of the system in the invention.

Throughout the figures, same reference numerals indicate similar or corresponding features.

### DETAILED EMBODIMENTS

The invention is explained below by way of example within the context of recording streaming video to, and supplying streaming video from, a memory. The memory comprises, e.g., an HDD, an optical disk drive or a solid state memory. In the example below, it is assumed that the memory comprises an HDD.

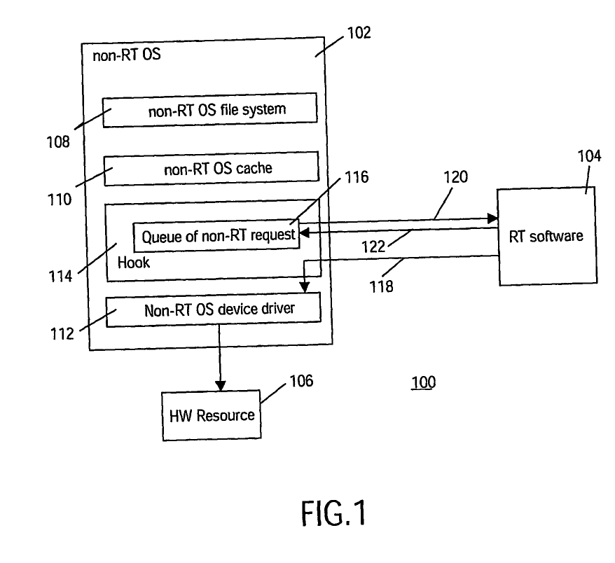

FIG. 1 is a block diagram of a system 100 in the invention. System 100 comprises a host OS (HOS) 102 that is general-purpose, i.e., non-RT. System 100 also comprises RT software 104, e.g., software with an RTFS to enable video streaming applications. System 100 further comprises hardware resource 106, here an HDD.

HOS 102 comprises a HOS file system 108, a HOS cache 110, and a HOS device driver 112 to operate resource 106. In order to have RT software 104 co-exist with HOS 102, the latter is provided with a software hook 114 that enables communication between HOS 102 and RT software 104. Both HOS 102 and RT software 104 have processes that request access to HDD 106. Hook 114 intercepts all requests from the processes of HOS 102 for access to HDD 106, and puts them into a queue 116. This ensures that the non-RT requests do not interfere with RT requests 118 from RT software 104. Hook 114 further provides information 120 to RT software 104 about the non-RT requests in queue 116. For example, the information comprises disk location and size of the request. This enables RT software 104 to determine the proper time for execution of the pending non-RT requests so that these are prevented from interfering with the RT traffic. Requests in queue 116 get executed only after explicit order 122 from RT software 104. In addition, RT software 104 can determine the sequence wherein the non-RT requests are executed, e.g., to optimize resource usage within system 100. Hook 114 recognizes requests 118 from RT software 104 for access of resource 106 and lets them through immediately so that they get executed without delay. Note that in this manner RT software 104 is enabled to use device driver 112 of HOS 102. A non-RT OS typically uses a request queue to device drivers. Using this queue mechanism in hook 114 simplifies implementation of hook 114.

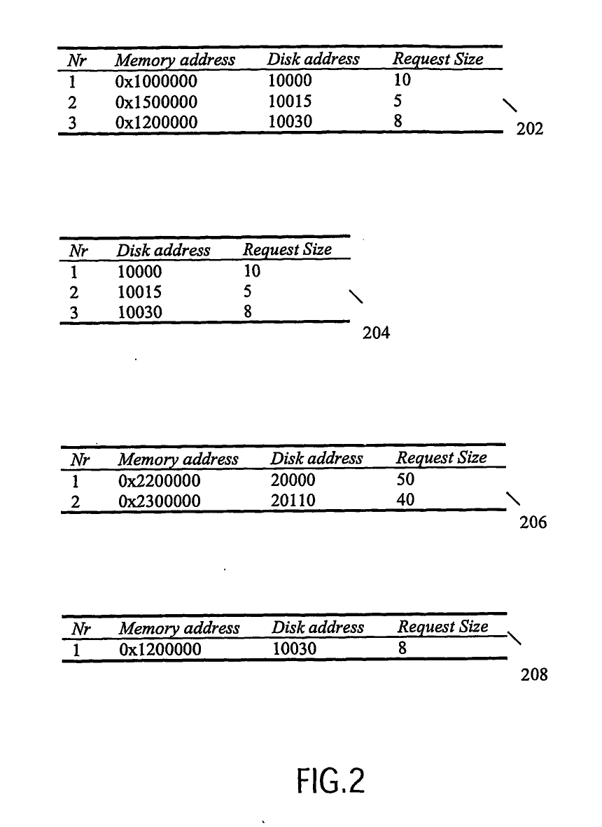

FIG. 2 comprises tables 202, 204, 206 and 208 illustrating operation of system 100. HOS 102 issues multiple conventional requests. Hook 114 puts these requests into queue 116. Table 202 gives an example of the requests put into queue 116. Hook 114 provides a list of the requests to RT software 104. The list is formatted so that only the required information is passed on to RT software 104. Table 204 is an example of the list based on the requests of table 202. RT software 104 first issues some RT requests 118 that are executed by driver 112 without delay. Table 206 is an example of the RT requests 118. Then, RT software 104 finds there is time to execute one or more of the pending HOS requests and instructs hook 114 via channel 122 to have these executed. For example, hook 114 is instructed to have requests #1 and #2 of table 202 executed. Hook 114 passes these requests on to driver 112 where they get executed. The remaining request #3 of table 202 is kept pending in queue 116, as shown in table 208, possibly together with new requests issued by HOS 102.

1. A method of enabling RT software co-existing with a non-RT OS to share a resource between the RT software and the non-RT OS, the method comprising:
enabling the RT software to check a request from the non-RT OS for access of the resource; and
enabling the RT software to determine when the request is executed.

2. The method of claim 1, comprising enabling the RT software to have the request put into a queue.

3. The method of claim 1, wherein the RT software comprises an RTFS.

4. The method of claim 1, further comprising enabling the RT software to access the resource through a device driver of the non-RT OS.

5. The method of claim 1, wherein the resource comprises a memory.

6. The method of claim 5, wherein the memory comprises a HDD.

7. A data processing system comprising:
RT software;
a non-RT OS;
a resource shared between the RT software and the non-RT OS;
wherein:
the RT software is enabled to check a request from the non-RT OS for access of the resource; and
the RT software is enabled to determine when the request will be executed.

8. The system of claim 7, wherein the RT software is enabled to have the request put into a queue.

9. The system of claim 7, wherein the RT software comprises an RTFS.

10. The system of claim 7, wherein the RT software is enabled to access the resource through a device driver of the non-RT OS.

11. The method of claim 7, wherein the resource comprises a memory.

12. The method of claim 11, wherein the memory comprises an HDD.
